(19) United States
(12) Patent Application Publication
(10) Pub. No.: US 2019/0100661 A1
(43) Pub. Date: Apr. 4, 2019

(54) Fire resistant foam composition and method

(71) Applicants: Walter Dan Stogner, Celina, TX (US); William T. Frazier, Pittsburgh, PA (US); Mack L. Knotts, Ft. Worth, TX (US); Sean K. White, Celina, TX (US)

(72) Inventors: Walter Dan Stogner, Celina, TX (US); William T. Frazier, Pittsburgh, PA (US); Mack L. Knotts, Ft. Worth, TX (US); Sean K. White, Celina, TX (US)

(21) Appl. No.: 16/148,898

(22) Filed: Oct. 1, 2018

Related U.S. Application Data
(60) Provisional application No. 62/568,175, filed on Oct. 4, 2017.

(51) Int. Cl. C09D 5/18; C09D 175/04; C08J 9/00; C08K 7/04; C08K 3/22

(52) U.S. Cl. CPC C09D 5/18; C09D 175/04; C08J 9/0066; C08K 2003/2224; C08K 3/22; C08J 2207/04; C08J 2375/04; C08K 7/04

(57) ABSTRACT

In one embodiment, ground mineral wool is added to conventional polyurethane composition A or B to improve fire or flame resistant properties. In a second embodiment, a larger percentage of ground mineral wool is used in combination with a higher water concentration in order to substantially reduce the hydrocarbon content of the resulting foam. In a third embodiment, a foam composition is substantially re-formulated to reduce polyol concentration. Preliminary testing has suggested that it is possible to create an effective foam-like insulation without requiring the “foam” components to have a high polyol concentration.

### RELATED APPLICATIONS

This is a U.S. Non-Provisional Patent Application is related to U.S. Provisional Application No. 62/568,175 filed by applicants on Oct. 4, 2018, and claims the benefit of that priority date.

### BACKGROUND

### Field of the Invention

The Inventions Disclosed And taught herein relate generally to polyurethanes and their manufacture, and more specifically, are related to methods for the manufacture and installation of isocyanate and polyurethane based foams with improved flame retardation and charring properties.

### Prior Art

Spray foam insulation is an alternative to traditional building insulation such as fiberglass. A two-component mixture composed of isocyanate and polyol resin comes together at the tip of a gun, and forms an expanding foam that is sprayed onto roof tiles, concrete slabs, into wall cavities, or through holes drilled in into a cavity of a finished wall.

Various systems are used to apply the spray foam. The two component high pressure system is generally used in new home construction. It is a quick expanding type of spray foam. The two component low pressure spray foam is another system that is used primarily for remodel jobs where there are existing walls with drywall already in place. This is also known as a slow rise formula and often referred to as injection foam

Spray foam insulation can be categorized into two different types: open cell and closed cell.

### Open Cell Foam Insulation

Open cell is a type of foam where the tiny cells are not completely closed. Open cell is less expensive because it uses fewer chemicals. It is a very good air barrier but does not provide any type of water vapor barrier. It is much more sponge-like in appearance. It is often used for interior walls because it provides sound reduction. It is not recommended for outdoor applications.

### Closed Cell Foam Insulation

Closed cell foam insulation is much denser than open cell. It has a smaller, more compact cell structure. It is a very good air barrier as well as a water vapor barrier. It is often used in roofing projects or other outdoor applications, but can be used anywhere in the home.

### Polyurethane Foams

US Patent Publication 20130030067 to Mooney et al provides a thorough background on polyurethane foam, and much of that background is provided herein.

Polyurethane foams articles are used extensively in a wide array of commercial and industrial applications. The popularity of polyurethane foam articles is due in part to the fact that the physical properties of a polyurethane foam article may be selectively altered based on the formulation of reactants which form the polyurethane foam article. The formulation may be developed to provide a polyurethane foam article that is soft, flexible and open-celled which can be used in applications such as seat cushions. On the other hand, the formulation may be developed to provide a polyurethane foam article that is rigid, structural, thermally resistant and closed-celled and which therefore can be used as a thermal insulation panel.

The most common method of forming polyurethane foam articles is the mixing and, subsequent reaction, of a polyol (e.g. a resin composition) with an isocyanate in the presence of a blowing agent. Generally, when the resin composition is mixed with the isocyanate to form a reaction mixture in the presence of the blowing agent, a urethane polymerization reaction occurs. As the urethane polymerization reaction occurs, the reaction mixture cross-links to form the polyurethane and gas is simultaneously formed and released. Through the process of nucleation, the gas foams the reaction mixture thereby forming voids or cells in the polyurethane foam article.

The resin composition typically comprises one or more polyols, a cell opening agent, a cross linking agent, a catalyst, an adhesion promoting agent and various additives. The blowing agent creates the cells in the polyurethane foam article as described above. The cell opening agent helps open the cells so that the cells form an interconnected network and improves the stability of the polyurethane foam article. The cross-linking agent promotes cross-linking of the reaction mixture which results in the polyurethane foam article. The catalyst controls reaction kinetics to improve the timing of the polymerization reaction by balancing a gel reaction and the blowing agent to create the polyurethane foam article, which is stable. Other additives, such as adhesion promoting agents (e.g. a protic solvent), may be added to the formulation in order to facilitate wet out of the reaction mixture and promotes adhesion of the polyurethane foam article to substrates upon which the polyurethane foam article is disposed. For example, the substrate may be a thermoplastic shell or thermoplastic liner of a picnic cooler. The density and rigidity of the polyurethane foam article may be controlled by varying the chemistry of the isocyanate, therein composition and/or the blowing agent, and amounts thereof. Other additives that are often included within the polyurethane foam product are fire retardants, typically halogenated—(e.g., brominated and chlorinated materials) and phosphorus-containing retardant materials.

Plastic foams have been utilized as thermal insulating materials, light weight construction materials, and flotation materials and for a wide variety of other uses because of their excellent properties. Until recently, their use has been somewhat limited in environments where there is danger of fire because of their substantial fuel contribution, their contribution to rapid flame spread and the fact that they generate large quantities of noxious smoke on thermal decomposition when burned or heated to an elevated temperature. This has limited the commercial development of plastic foams, and large amounts of money and much research time have been expended in attempts to alleviate these problems.

With the present interest in conserving heating fuel, many existing buildings are installing additional insulation, and newly constructed buildings are including more insulation than was formerly used.

A previously common type of foam insulation for existing structures are urea formaldehyde foams, which are foamed in place between the outside wall and the inside wall of the structure, with or without additional, fiberglass insulation. Fiberglass insulation alone can be considered to be porous in nature since it is generally a mat of fine glass fibers, which can contribute to lower insulation values by allowing air circulation within the walls. Foam insulations, however, form an air barrier between the interior and exterior walls of a structure, and thus form a generally impervious barrier to air circulation, thereby making them better insulation materials. Unfortunately, the urea formaldehyde foam that has been used spontaneously decomposes, releasing formaldehyde fumes in quantities which may be toxic. The use of urea formaldehyde foams in construction is prohibited in many building codes for this reason.

### Polyurethane Foam Insulation

Another type of material often used for insulation is polyurethane foam. However, polyurethane foam provides a substantial fuel contribution, spreads flame rapidly, and releases toxic gases including carbon dioxide, carbon monoxide and hydrogen cyanide when burned.

### Rigid Polyurethane Foam

Rigid polyurethane foams are generally prepared by reacting an organic polyisocyanate with a polyol. For most commercial purposes, the reaction is conducted in the presence of a foaming agent, surfactant, catalyst and possibly other ingredients.

### Ignition Barrier or Thermal Barrier Requirements

Examples of improved foams can meet ignition barrier or thermal barrier requirements without the use of a secondary system. On the construction side, this will greatly reduce install time and cost related to constructibility, worker exposure, inspection, and reliability of the system. On the residential or commercial occupant side, this has the potential to increase the time of fire rated assemblies that are already using standard isocyanate and polyurethane based foams, thus improving safety and increasing potential survivability of the occupants.

The International Building Code® (IBC) and the International Residential Code® (IRC) define an approved thermal barrier as one which is equal in fire resistance to 12.7 mm (½ inch) gypsum wallboard. In essence, the model building codes define ½-inch gypsum wallboard as a prescriptive thermal barrier; approved equivalents (non-prescriptive thermal barriers) must perform as well as or better than ½-inch gypsum wallboard in fire testing as described below.

Non-prescriptive thermal barriers (termed “equivalent thermal barriers”) must undergo a temperature transmission fire test wherein the temperature rise of the underlying polyurethane foam is limited to not more than 121° C. (250° F.) after 15 minutes of fire exposure complying with the standard time temperature curve of ASTM E 119 (Test Methods for Fire Tests of Building Construction Materials). Additionally, equivalent thermal barriers must undergo a fire integrity test to establish that they will sufficiently remain in place during a fire scenario by passing a large-scale, 15-minute fire test. Equivalent thermal barriers meeting this criterion are termed a “15-minute thermal barrier” or classified as having an “index of 15.”

In effect, equivalent thermal barriers (i.e., other than the prescriptive ½-inch thick gypsum wallboard) must undergo two fire tests:
(1) A temperature transmission test (such as a modified ASTM E 119, the actual thermal barrier test apparatus being smaller than the typical large-scale wall or roof/ceiling test assemblies); and
(2) A fire integrity test (a large-scale fire test such as NFPA 286 [with a specific acceptance criteria defined within the IBC or IRC], UL 1040, UL1715 or FM 4880).

### Flame Retardants

One approach to improving fire resistance is to provide a flame retardant agent in the foam composition. One type of flame retardant agent is an endothermic decomposition agent, such as magnesium hydroxide, Mg(OH)₂,

This class of flame retardants is primarily condensed phase in its activity, but there is also some vapor phase action. When this flame retardant is heated, it decomposes endothermically to cool the condensed phase (thus preventing further heat-induced decomposition and pyrolysis) and typically releases a nonflammable gas. This nonflammable gas dilutes the total amount of fuel in the vapor phase which either prevents/delays ignition or keeps heat release low, allowing for self-extinguishment once the external flame is removed from the polymer.

The types of additives that fall into this class are typically mineral fillers, including hydroxides such as aluminum hydroxide (also known as alumina trihydrate) and magnesium hydroxide, as well as carbonates such as hydromagnesite. Organic carbonates can also be used as flame retardants, but they are not as effective as mineral filler systems. This is because the mineral filler flame retardants bring one additional benefit to the condensed phase: they dilute the total amount of fuel in the condensed phase, since after they release their nonflammable gas and cool the condensed phase, they are typically inorganic oxides, which cannot be burned further. Those oxides have not only replaced flammable polymer fuel, but sometimes will fuse together and form protective ceramic barriers as well.

### Methods for Creating Char Layer

Another approach to improving fire resistance is to provide a charring agent that creates a char layer when the foam is subjected to flame or heat .

Modesti [Ref 1] discusses three types of charring agents-ammonium polyphosphate, melamine cyanurate and expandable graphite. All those compounds lead to the formation of a superficial char layer that prevents further decomposition, but they act in three different ways:
Ammonium polyphosphate (APP) leads to the formation of a char layer through the linking of phosphates to the ester group; the latter are readily eliminated forming conjugated double bonds, which finally cyclize to give char;
Melamine cyanurate (MC) acts through endothermic decomposition that leads to evolution of ammonia and formation of condensation polymers; and
Expandable graphite (EG) leads to the formation of a char layer characterized by the presence of “worms”, deriving from its expansion.

Several example compositions appear to quickly provide an effective char layer in a manner that is different from the mechanisms described by Modesti. Without being limited by theory, Applicants propose that ground mineral wool is an example novel type of char-promotion agent and suggest a possible mechanism for its effectiveness. One theory is that ground mineral wool is an effective sintering agent, whereby the ground mineral wool particles are readily sintered together at a temperature below the particle melting temperatures.

### Prior Art Use of Mineral Wools

Mineral wool is provided as batts for wall or ceiling insulation.

U.S. Pat. No. 4,557,973 to Ali (CA1223896 A1) describes the use of mineral wool fibers introduced as slurries in gypsum board and plaster formulations in other to improve fire-resistant properties.

European Patent Application 1893404 (WO2006134236) to Fellman at al describes a fire protection element comprising at least two mineral wool layers sandwiching an inorganic layer which literate water or carbon dioxide in the presence of heat. Feldman notes that it is previously known to use mineral wool in fire protection slabs. The reason for this are the good fire protection properties of the mineral wool itself. It is also known to e.g. between two layers of mineral wool such as stone wool arrange an inorganic material layer, consisting of a dehydrating hydroxide as a fire retardant in combination with a binder, which is to bind the mineral wool slabs together. Such solutions are described for example in prior art in publications EP 1239093 A2, EP 0741003 B1, EP 0485867 B1 and EP 0353540 B2.

### REFERENCES

1. “Flame retardancy of polyisocyanurate-polyurethane foams: use of different charring agents” M. Modesti*, A. Lorenzetti Polymer Degradation and Stability 78 (2002) 341-347
2. International plastics flammability handbook, 2nd ed., J. Troitzsch, (Ed.), Hanser Publishers, Munich, Vienna, New York, 1990,

### SUMMARY

Despite the cost differential between drawn, or textile, glass fiber and blown glass or mineral wools, it does not appear that prior art has heretofore successfully added quantities of blown glass or mineral wool into an isocyanate based foam product because of clumping, non refinement, and dispensability of these fibers.

Applicants suggest a representative method for incorporating mineral wool and a secondary flame retardant into an isocyanate foam which does not introduce extraneous or deleterious constituents or require expensive capital investment for auxiliary equipment. Ground mineral wool, or similar materials such as ground blown glass, may be blended with appropriate amounts of secondary fire retardant, such as an inorganic metal based flame retardant, in such a fashion that the individual mineral wool fiber segments or particles are dispersed evenly and suspended in solution. In this form, the mineral wool is readily and accurately meterable into isocyanate foam formulas using conventional equipment and readily disperses throughout the aqueous mixture.

In a first embodiment of the present disclosure, ground mineral wool is added to conventional polyurethane composition A or B. In accordance with a first embodiment of the present disclosure, a flame-retardant polyurethane foam made by reacting together a first and second reaction mixture is described; the first and second reaction mixtures comprising a polyol wherein substantially all of the hydroxyl groups on the polyol are free; an isocyanate; a surfactant; an aqueous blowing agent; a polyurethane producing catalyst; a ground mineral wool charring agent; and a magnesium hydroxide flame retardant. A method of making a flame-retardant polyurethane foam is described, the method comprising (a) mixing an untreated polyol in which substantially all of the hydroxyl groups are free, a surfactant, a polyurethane forming catalyst, and water to form a first aqueous solution; (b) adding to the first aqueous solution mixture a second solution containing a polyisocyanate; and (c) allowing the mixture to foam.

In a second embodiment, a larger percentage of ground mineral wool is used in combination with a higher water concentration in order to substantially reduce the hydrocarbon content of the resulting foam.

In a third embodiment, a foam composition is substantially re-formulated to reduce polyol concentration. Preliminary testing has suggested that it is possible to create an effective foam-like insulation without requiring the “foam” components to have a high poll concentration.

In one example, a method for preparing a water blown, low density, polyurethane foam, is described, the method which comprises contacting at least one polyisocyanate with at least one natural polyol in an amount from about 20 wt. % to about 70 wt. %, at an Isocyanate Index of 10 to 120, more preferably at an Index between 20 to 50, in the presence of a blowing agent composition comprising at least 2 wt. % water, preferably at least about 5 wt. % water, and an effective amount of a catalyst composition comprising a gelling catalyst which and a blowing catalyst, the foam having a density of 0.3 lb/ft³ to 5 lb/ft³ (6 Kg/m³ to 80 Kg/m³). In further accordance with aspects of this embodiment, the natural polyol is sucrose, invert, molasses, or a combination thereof, and provides an open-cell foam with a low compressive strength, and good tensile strength.

In accordance with further aspects of the present disclosure, a composition for preparing polyurethane foam is described, the composition comprising an A-side component comprising one or more isocyanates, and a B-side component comprising between 20 to about 70 wt. % of natural polyol, between about 0.5 wt. % and 10 wt. % water, a surfactant in an amount between about 1.0 wt. % and about 5 wt. %, between about 0.05 to about 10 wt. % of a blowing catalyst, from about 0.5 wt. % to about 5 wt. % of a chain extender, an amine catalyst in an amount from about 0.01 wt. % to about 10 wt. %, a plasticizer in an amount ranging from about 0.01 wt. % to about 15 wt. %, and a fire retardant in an amount ranging from about 5 wt. % to about 40 wt. %, and wherein the volume ratio of A-side component to B-side component is about 1:1.

### Flame Retardant and Charring Additives

In some embodiments, a ground mineral wool charring agent and a metal hydroxide flame retardant agent, such as Mg(OH)₂ are added to the foam component(s).

Metal hydroxides function in both the condensed and gas phases of a fire by absorbing heat and decomposing to release their water of hydration. This process cools both the polymer and the flame and dilutes the flammable gas mixture.

### Physical Action

There are several ways in which the combustion process can be retarded by physical action (Troitzsch, 1990).
(a) By cooling. Endothermic processes such as triggered by additives such as cool the substrate to a temperature below that required to sustain the combustion process.
(b) By formation of a protective layer (coating). The condensed combustible layer can be shielded from the gaseous phase with a solid or gaseous protective layer. In some embodiments, the formation of this “char layer” is facilitated by a “charring agent” agent such as ground mineral wool. The condensed phase is thus cooled, smaller quantities of pyrolysis gases are evolved, the oxygen necessary for the combustion process is excluded and heat transfer is impeded.

### Chemical Action

The most significant chemical reactions interfering with the combustion process take place in the solid and gas phases (Troitzsch, 1990).
(a) Reaction in the gas phase. The free radical mechanism of the combustion process which takes place in the gas phase is interrupted by a flame retardant such as Mg(OH)₂. The exothermic processes are thus stopped, the system cools down, and the supply of flammable gases is reduced and eventually completely suppressed.
(b) Reaction in the solid phase. Here two types of reaction can take place. Firstly, breakdown of the polymer can be accelerated by the flame retardant, causing pronounced flow of the polymer and, hence, its withdrawal from the sphere of influence of the flame, which breaks away. Secondly, the flame retardant can cause a layer of carbon to form on the polymer surface. This can occur, for example, through the dehydrating action of the flame retardant generating double bonds in the polymer. These form the carbonaceous layer by cyclizing and cross-linking.

### BRIEF DESCRIPTION OF THE DRAWINGS

FIG. 1A is a front perspective view of a test room showing the back wall and left wall.

FIG. 1B is a front view of the front wall of the test room of FIG. 1A before ceiling joist installation.

FIG. 1C is a front view of the test room of FIG. 1A prior to sheetrock installation on the front wall.

FIG. 2A is a front view of a sprayed-on polyurethane foam composition with a high ground rock wool and high water composition with accelerated sunlight cure.

FIG. 2B is a front perspective view of the sprayed-on polyurethane foam composition of FIG. 2A sprayed onto test chamber; the back wall and scraped even with the wall studs; and composition sprayed onto the test chamber right side wall before scraping.

FIG. 3 is a front view of a sprayed-on polyurethane foam composition of FIG. 2C after a test burn.

FIG. 4 is a side view of right wall section of FIG. 3 after the test burn, showing a well-defined thin char layer.

FIG. 5 is a side view of back wall section of FIG. 3 after the test burn, showing a well-defined thin char layer.

FIG. 6 is a bottom view of a ceiling wall section cutout after the test burn, showing a well-defined thin char layer.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DEFINITIONS

The following definitions are provided in order to aid those skilled in the art in understanding the detailed description of this specification and claims.

The term “compressive strength”, as used herein, means the property of foam articles as determined by the test procedure described in ASTM D-3575-77, expressed in pounds per square inch (psi), or in accordance with DIN 53,577. The term “low compressive strength” as used herein refers to polyurethane foams having a compressive strength of less than about 20 at 60% compression.

The phrases “flame resistant,” “fire resistant,” “flame retardant” and “fire retardant” as used herein mean: (a) having an ability to not support a flame, fire and/or combustion, either while a flame or fire is present, or once a source of heat or ignition is removed; and/or (b) being retardant to, or incapable of, burning (being fireproof--undergoing virtually no change when exposed to flame, fire and/or combustion process). A flame resistant substrate or other material may char and/or melt.

The phrase “flame retardant chemical”, and “flame resistant substance” as used herein means an element, chemical compound, agent or substance that has the ability to reduce or eliminate the tendency of a substrate to burn when the substrate is exposed to a flame or fire, and that is suitable for use with one or more substrates, which may be determined by those of skill in the art.

As used herein, the term “endothermic decomposition flame retardant” means a solution, chemical compound, or mineral that, when exposed to heat or flame, decomposes into elements or compounds such as water vapor or CO₂, thereby diluting the gas phase of the flame, and the formation of residue, char, or glass, which isolates the remaining material from the heat source. An example endothermic decomposition flame retardant is Magnesium Hydroxide Mg(OH)₂.

The phrase “flame spread” as used herein means the propagation of a flame front, as determined by ASTM E-84.

The phrase “flame spread rate” as used herein means the distance traveled by a flame front during its propagation per unit of time under specified test or other conditions.

The term “flammability” as used herein means a measure of the extent to which a substrate or material will support combustion under specified test or other conditions.

As used herein, the term “charring” means a chemical process of incomplete combustion of certain solids when subjected to high heat. The resulting residue matter is called char. By the action of heat, charring removes hydrogen and oxygen from the solid, so that the remaining char is composed primarily of carbon. Once this layer starts to form, the remaining material underneath the char is limited in its ability to give a fuel source to the heat or flame. The process operates in condensed phase by preventing fuel release and providing thermal insulation for underlying polymer. In prior art, the charring process may be promoted by a chemical reaction or by an exfoliation process. Applicants suggest that ground rock wool may support an alternate charring mechanism, such as a sintering process where the ground rock wool particles sinter at a temperature below their melting point, and thereby provide a support surface for a char layer.

As used herein, the term char-promotion agent means a substance, compound, or mixture that facilitates the formation of a char layer. The addition of ground rock wool in foam compositions has been demonstrated to improve fire retardant or flame spread performance, and applicants suggest that this improvement may be due in part to the rock wool particles serving as a char promotion agent.

As used herein, the term “mineral wool” also known as mineral fiber, mineral cotton, mineral fibre, man-made mineral fibre (MMMF), and man-made vitreous fiber (MMVF), is a general name for fiber materials that are formed by spinning or drawing molten minerals (or “synthetic minerals” such as slag and ceramics.) The nomenclature of these wool products can simply be done by putting the parent/raw material name in prefix to wool like wool from glass is glass wool, wool from rock is stone wool and so on. Specific mineral wool products are stone wool and slag wool.

As used herein, the term “stone wool or rockwool” means a furnace product of molten rock at a temperature of about 1600° C., through which a stream of air or steam is blown. More advanced production techniques are based on spinning molten rock in high-speed spinning heads somewhat like the process used to produce cotton candy. The final product is a mass of fine, intertwined fibers with a typical diameter of 2 to 6 micrometers. Mineral wool may contain a binder, often a polymer, and an oil to reduce dusting. Rockwool products are classified as non-combustible per ASTM E 136. When used as unfaced insulation, mineral wool has Flame Spread and Smoke Developed ratings of 0. Foil-faced mineral wool products have a Flame Spread of 25 and Smoke Developed of 0. These ratings are classified per ASTM E 84.

As used herein, the term “ground rock wool” means the size reduction of rockwool through grinding, cutting, milling, pulverizing into small enough partial sizes to be integrated into solution and/or pass through specified filters or screens for its dispersed use in an end product. The term “ground rock wool” refers to the product of any process for producing small particles of rock wool. Initially, these particles were provided by ball-milling a conventional rock wool material. Without being limited by theory, applicants suggest that by forming mineral wool fibers and then breaking that material, the ground particles may have more desirable properties than can be provided by directly milling a mineral material. For instance, the porosity or surface properties of a ground fiber may be different and more desirable from the properties of a directly processed mineral. In particular, the ground particles may more readily sinter than a directly processed mineral. On the other hand, it is possible that most or all of the observed benefit of ground rock wool could be provided by a product of simpler processing, such as the direct milling of a mineral.

The expression “polyurethane foam”, as used herein, generally refers to cellular products as obtained by reacting polyisocyanates with isocyanate-reactive hydrogen containing compounds, using foaming agents, and in particular includes cellular products obtained with water as a reactive foaming agent (involving a reaction of water with isocyanate groups yielding urea linkages and carbon dioxide and producing polyuria-urethane foams).

As used herein, all numerical ranges provided are intended to expressly include at least all of the numbers that fall within the endpoints of ranges.

Often, ranges are expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

The term “optional” or “optionally” means that the subsequently described event or circumstance may or may not occur, and that the description includes instances where said event or circumstance occurs and instances where it does not. For example, the phrase “optionally substituted” means that the compound referenced may or may not be substituted and that the description includes both unsubstituted compounds and compounds where there is substitution.

The term “open cell” or “open cell foam”, as used herein, refers to a foam having at least 20 percent open cells as measured in accordance with ASTM D 2856-A.

As used herein, “MDI” refers to methylene diphenyl diisocyanate, also called diphenylmethane diisocyanate, and the isomers thereof. MDI exists as one of three isomers (4,4′ MDI, 2,4′ MDI, and 2,2′ MDI), or as a mixture of two or more of these isomers. As used herein, unless specifically stated otherwise, “MDI” may also refer to, and encompass, polymeric MDI (sometimes called PMDI). Polylmeric MDI is a compound that has a chain of three or more benzene rings connected to each other by methylene bridges, with an isocyanate group attached to each benzene ring. MDI as used herein may have an average functionality from about 2.1 to about 3, inclusive, with a typical viscosity of about 200 mPa at 25.degree. C.

The term “functionality”, “MDI functionality”, or “isocyanate functionality”, as used herein, refers to the number average isocyanate functionality of all isocyanates used in preparing the isocyanate, and is typically referred to as Fn.

The term “isocyanate index”, or “NCO index”, refers to the ratio of NCO groups over isocyanate-reactive hydrogen atoms present in a formulation, given as a percentage. In other words, the NCO-index expresses the amount of isocyanate actually used in a formulation with respect to the amount of isocyanate theoretically required for reacting with the amount of isocyanate-reactive hydrogens used in a formulation.

As used herein, the term “toluene diisocyanate” encompasses all forms and combinations of isomers of this compound. Virtually all of the toluene diisocyanate reacts mono-functionally as the para isocyanate group is more reactive than the ortho isocyanate group.

As used herein, the term “polyurethane foam composition” means a composition of isocyanates and polyols. Other materials are typically added to aid processing the polymer or to modify the properties of the polymer.

As used herein, the term “Part A foam insulation composition”means an isocyanate composition such as the aromatic diisocyantes, toluene diisocyanate (TDI) and methylene diphenyl diisocyanate, MDI.

As used herein, the term “Part B foam insulation composition”means a polyol composition.

### Description of Embodiment—Polyurethane Foam Compositions

The written description of specific compositions described are presented as examples, and are not intended to limit the scope of the specification. The examples are intended to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created a polyurethane foam with improved flame retardation and charring properties. The foams exhibit a high burn resistance, as determined by a number of tests, including flame spread and/or smoke development.

The foams are polyurethane foams which include the following categories: Conventional foam, High Resiliency (HR) foam, Filled Foams including foams filled with reground polyurethane foam as a type of filler, High-Load-Bearing foam, Spray Foams, Insulation Foams, Packaging Foams, and Reticulated foam as described in U.S. Pat. Nos. 3,475,525, 3,061,885, and 5,312,846, the appropriate sections of the disclosures of which are incorporated herein by reference.

Without being bound by theory, applicants have discovered unexpectedly good flame retardation and fire resistance properties by adding a char-promoting agent and a flame retardation agent to conventional polyurethane foam-producing compositions. In one embodiment, the char-promoting agent is a ground rock wool, and the flame retardation agent is Mg(OH)₂.

Polyurethane foam compositions have demonstrated improved flame spread and fire resistance properties through two approaches. In a first approach, ground rock wool and a flame retardant agent such as magnesium hydroxide replace or supplement typical additives in a conventional Part A or Part B mix.

In a second approach, the polyol concentration in a part B composition is substantially lowered in favor of higher ground rock wool concentration and higher water concentration. Although the compositions may be prepared and sprayed in a conventional manner, the Part B composition is substantially less expensive that prior art compositions; and the charring characteristics are different from prior art compositions. In particular, there is less smoke and it is light colored rather than dark; and a thick dark char layer is formed quickly.

In either approach, at least a portion of the ground rock wool may be provided in a Part A composition.

In one embodiment, a polyurethane foam of the present disclosure is produced by combining a polyol, a multifunctional isocyanate, a ground rock wool char-promoting agent, a flame retardant agent, and a non-halogen blowing agent, preferably water, or a combination of water and another non-halogen containing blowing agent, with one or more of a class of plasticizers and one or more of a class of crosslinker/extenders, and, optionally, in the presence of catalysts, stabilizers, emulsifiers, and other auxiliaries and additives, as required depending upon the target closed cell density of the product polyurethane foam product. Each of these ingredients will be discussed below.

In another embodiment, the concentration of water in the polyurethane foam composition can be substantially increased when ground rock wool is added. The combination of increased water content and increased ground rock wool appears to provide a substantially less expensive foam composition with improved flame spread and fire resistance properties.

### Polyols

A basic raw material for the production of polyurethane foams disclosed intros embodiment is a polyol, which may be an aliphatic or aromatic polyhydroxy compound, that will react with the isocyanate. This polyol may be a polyether polyol, a polyester polyol, or combinations thereof. Polyether polyols are preferred. The polyols used in the compositions of the present disclosure are typically used in an amount ranging from about 20 pphp (parts per hundred parts, or wt. %, equivalently) to about 70 pphp, and more preferably from about 25 pphp to about 55 pphp, inclusive, as well as in amounts within this range, such as about 49 pphp.

The polyols which can be utilized in the present invention when in combination with one or more natural polyols include, but are not limited to, the following polyether polyols: alkylene oxide adducts of polyhydroxyalkanes; alkylene oxide adducts of non-reducing sugars and sugar derivatives; alkylene oxide adducts of polyphenols; and alkylene oxide adducts of polyamines and polyhydroxyamines. Alkylene oxides having two to four carbon atoms generally are employed, with propylene oxide, ethylene oxide and mixtures thereof being preferred.

The polyether polyol usually has a hydroxyl functionality between 2 and 3 and a molecular weight between 1000 and 6000. The polyol or polyol blend should have an average hydroxy functionality of at least 2. The equivalent weight is determined from the measured hydroxyl number. The hydroxyl number is defined as the number of milligrams of potassium hydroxide required for the complete hydrolysis of the fully acetylated derivative prepared from one gram of polyol. The relationship between the hydroxyl number and equivalent weight is defined by the equation: OH=56,100/equivalent weight, where OH equals the hydroxyl number of the polyol.

The polyols may include the poly(oxypropylene) and poly(oxyethylene-oxypropylene) triols. Ethylene oxide, when used can be incorporated in any fashion along the polymer chain. Stated another way, the ethylene oxide can be incorporated either in internal blocks, as terminal blocks, or may be randomly distributed along the polyol chain.

A portion or all of the polyol component may be added in the form of a polyol polymer in which reactive monomers have been polymerized within a polyol to form a stable dispersion of the polymer solids within the polyol.

The amount of polyol used is determined by the amount of product to be produced. Such amounts may be readily determined by one skilled in the art.

Polyether polyols are most commonly used in the production of polyurethane foams. Polyether polyols can be made by the addition reaction of alkylene oxides to such initiators as sucrose, glycerin, triethanol amine, and the like. Suitable alkylene oxides include ethylene oxide, propylene oxide, butylene oxide, isobutylene oxide, N-hexyl oxide, styrene oxide, trimethylene oxide, tetrahydrofuran, epichlorohydrin, and the like. Propylene oxide is preferred to ethylene oxide as the former yields polyether polyols with secondary hydroxyl groups. Representative examples of polyether polyols are polyether diols such as polypropylene glycol, polyethylene glycol and polytetramethylene glycol; polyether triols such as glycerol triols; polyether tetrols and pentols such as aliphatic amine tetrols and aromatic amine tetrols; polyether octols such as sucrose octol; and others such as sorbitol, trimethylol propane, and pentaerythritol.

The polyol can be suitable polyesters containing hydroxyl groups including, for example, the reaction products of polyhydric, preferably dihydric alcohols with the optional addition of trihydric alcohols and polybasic, preferably dibasic carboxylic acids. Examples of such carboxylic acids and their derivatives include dimerized and trimerized unsaturated fatty acids optionally mixed with monomeric unsaturated fatty acids such as oleic acid, dimethylterephthalate, terephthalic acid-bis-glycol esters, and polyalkylene terephthalate. Suitable polyhydric alcohols include glycols, e.g. ethylene glycol, propylene glycol, diethylene glycol, triethylene glycol, tetraethylene glycol, and higher polyethylene glycols and polyalkylene glycols.

Polyurethane foams are the largest single outlet for polyester polyols. Representative examples of polyester polyols that can be used to make polyurethane foams in accordance with the present disclosure also include ethylene and diethylene glycol adipates, butanediol adipate, polytetramethylene glycol adipate, hexanediol adipate, and the polyols produced from terephthalate and derivatives thereof, including, for example, dimethyl terephthalate or the digestion product of polyethylene terephthalate, reacted with diols and triols.

These compounds are merely illustrative examples of polyol sources that may be used in connection with this invention, and it is to be understood that any known polyol source that is acceptable in the making of polyurethane may be used.

### Isocyanates

Another required ingredient of the compositions disclosed herein is one or more isocyanates, such as monomeric and/or multifunctional isocyanates. Diphenylmethane diisocyanate (MDI) and toluene diisocyanate (TDI) are basic raw material in the production of polyurethane foams, both of which are monomeric and may be used in accordance with the compositions and methods of the present disclosure. Polyurethane foams in accordance with the present disclosure may also be produced from the reaction of polyols and polymeric diphenylmethane diisocyanate, a multifunctional isocyanate.

The compositions described herein may comprise a monomeric MDI component comprising 2,4′-MDI. As set forth previously herein, the terminology monomeric MDI denotes a component comprising the MDI isomers, such as 2,4′-MDI, 4,4′-MDI, or 2,2′-MDI. As compared to 4,4′-MDI and 2,2′-MDI, 2,4′-MDI is an asymmetrical molecule and provides two NCO groups of differing reactivities. Therefore, without intending to be limited by theory, the 2,4′-MDI is typically present in the polyisocyanate composition to optimize flexible polyurethane foaming reaction parameters such as stability and curing time of the flexible polyurethane foam. The is 2,4′-MDI is present in the monomeric MDI component in an amount greater than 10 parts by weight of the 2,4′-MDI based on 100 parts by weight of the monomeric MDI component. The 2,4′-MDI is more typically present in the monomeric MDI component in an amount of greater than 35, most typically greater than 65 parts by weight based on 100 parts by weight of the monomeric MDI component.

The monomeric MDI component may further include 2,2′-MDI and 4,4′-MDI. It is preferred that 2,2′-MDI is either not present at all in the monomeric MDI component or is present in small amounts, i.e., typically from 0 to 2, more typically 0.1 to 1.5 parts by weight based on 100 parts by weight of the monomeric MDI component. The 4,4′-MDI is typically present in the monomeric MDI component in an amount of from 0 to 65, more typically 20 to 55, and most typically 30 to 35 parts by weight based on 100 parts by weight of the monomeric MDI component.

The monomeric MDI component is typically present in the polyisocyanate composition in an amount of from 80 to 100, more typically 90 to 98 parts by weight based on 100 parts by weight of the polyisocyanate composition.

As indicated above, the polyisocyanate composition may also, optionally, comprise a polymeric diphenylmethane diisocyanate (MDI) component. The isocyanate, when present as a polymeric MDI component is typically present in the polyisocyanate composition to provide reactive groups, i.e., NCO groups, during a flexible polyurethane foaming reaction, as set forth in more detail below. The polymeric MDI component is typically a mixture of oligomeric diphenylmethane diisocyanates, i.e., a mixture of MDI and its dimer and/or trimer. The polymeric MDI component comprises a crude MDI having three or more benzene rings including NCO groups. The polymeric MDI is typically obtained through the condensation of aniline and formaldehyde in the presence of an acid catalyst, followed by phosgenation and distillation of a resulting polymeric amine mixture. The polymeric MDI component is typically present in the polyisocyanate composition in an amount of from 1 to 20, more typically 2 to 10 parts by weight based on 100 parts by weight of the polyisocyanate composition.

In accordance with the present disclosure, the compositions of the present disclosure are preferably prepared with an isocyanate having a functionality ranging from about 2.0 to about 3.0 (inclusive), and more preferably from about 2.1 to about 2.8, inclusive, including functionalities of 2.2, 2.3, 2.4, 2.5, 2.6, and 2.7, as well as ranges in between (e.g., from about 2.3 to about 2.7); and, an NCO content ranging from about 20.0 to about 40.0 wt. %, preferably from about 28.0 wt. % to about 35.0 wt. %, inclusive. Exemplary suitable isocyanates for use herein include, without limitation, Lupranate® M10 and Lupranate® M20, both polymeric MDI's (polymethylene polyphenylpolyisocyanate) available from BASF Corporation (Wyandotte, Mich.).

Other isocyanates can be utilized in this invention, either in place of or in combination with MDI, TDI, and/or polymeric MDI. Such isocyanate compounds are well known in the art, and are selected from, for instance, aliphatic, cycloaliphatic, and aromatic polyisocyanates, e.g., the alkylene diisocyanates and the aryl diisocyanates, and combinations thereof. Those skilled in the art are aware of properties that various isocyanates can add to a foam.

A wide variety of known isocyanate compounds may be used in accordance with the present invention, including esters of isocyanic acid. Any of the conventional polyisocyanates known in the art may be employed in the present invention. Examples of isocyanate sources suitable for use with the formulations and methods of the present invention include polyvalent isocyanates including diisocyanates, such as m-phenylenediisocyanate; p-phenylenediisocyanate; 2,6-trichloroethylenediisocyanate; naphthalene-1,4-diisocyanate; 2,4-trichloroethylenediisocyanate; diphenylmethane-4,4′-diisocyanate (MDI); 3,3′-dimethoxy-4,4′-biphenyl-diisocyanate; propylene-1,2-diisocyanate; 3,3′-dimethyldiphenylmethane-4,4′-diisocyanate; trimethylhexamethylene diisocyanate; xylenediisocyanate including xylylene-1,4-diisocyanate; hexamethylenediisocyanate; 4,4′-diphenylpropanediisocyanate; trimethylenediisocyanate; butylene-1,2-diisocyanate; cyclohexanediisocyanate; cyclohexylene-1,2-diisocyanate; cyclohexylene-1,4-diisocyanate; isophorone-diisocyanate (IPDI), dicyclohexylmethane-4,4′-diisocyanate, and the like; the aforementioned 2,4-tolylenediisocyanate (2,4-TDI); 2,6-tolylenediisocyanate (2,6-TDI); mixtures of 2,4-TDI and 2,6-TDI; dimer and trimer of 2,4-TDI; metaxylylenediisocyanate; 4,4′-biphenyldiisocyanate; diphenylether-4,4′-diisocyanate; 3,3′-ditoluene-4,4′-diisocyanate; dianisidinediisocyanate; 4,4′-diphenylmethanediisocyanate; 3,3′-diethyl-4,4′-diphenylmethanediisocyanate; 1,5-naphthalene diisocyanate; diisothiocyanates, such as p-phenylenediisothiocyanate; xylene-1,4-diisothiocyanate; ethylidine-diisothiocyanate and the like; triisocyanates, such as triphenylmethanetriisocyanate and the like including 4,4′,4″-triphenylmethanetriisocyanate; toluene-2,4,6-triisocyanate and the like; tetraisocyanates, such as 4,4′-dimethyldiphenyl methane-2,2′,5,5′-tetraisocyanate and the like; isocyanate prepolymers, such as an adduct of trichloroethylenediisocyanate with hexanetriol; an adduct of hexamethylene-diisocyanate with hexane triol; an adduct of trichloroethylenediisocyanate with hexane triol; an adduct of trichloroethylenediisocyanate with trimethylol propane, and the like. The polyisocyanates may also be used in the form of their derivatives, e.g., the reaction products with phenols, alcohols, amines, ammonia, bisulphite, HCl etc., and the polyester based isocyanate terminated prepolymer and IPDI. Individual examples of these are phenol, cresols, xylenol, ethanol, methanol, propanol, isopropanol, ammonia, methylamine, ethanolamine, dimethylamine, aniline and diphenylamine. Relatively high molecular weight addition products, e.g., of polyisocyanates with polyalcohols such as ethylene glycol, propylene glycol, trimethylolakanes or glycerol may also be used.

These compounds are merely illustrative examples of isocyanate sources that may be used in connection with this invention, and it is to be understood that any known isocyanate source that is acceptable in the making of polyurethane may be used.

Organic isocyanates useful in producing polyurethane foam in accordance with this invention are organic compounds that contain, on average, between about one and a half and about six isocyanate groups, and preferably about two isocyanate groups.

The amount of isocyanate to be used is dependent upon the isocyanate index of foam desired and the final properties of the foam to be formed. The isocyanate index is the percent of isocyanate present compared to the moles of isocyanate-reactive compounds, expressed as a percent. If the isocyanate index is 100, then there is a stoichiometric equivalent of the amount of isocyanate needed to react with the polyol component and the other active hydrogen containing components, i.e., water, in the system. If a 3 mole percent excess of isocyanate is incorporated into the foam, then the isocyanate index is 103. Generally speaking, as the isocyanate index increases, the amount of water and free hydroxyl groups available to react decreases.

### Blowing Agents

In addition to the isocyanate and polyol, the production of polyurethane foam may require the presence of a foaming or blowing agent. Fluorocarbon blowing agents such as trichlorofluoromethane have been used to produce foams in the past; however, the future of the fluorocarbon blowing agents depends upon government regulations, and thus their use in commercial products has been falling out of favor in the industry. The heat of reaction, and sometime externally applied heat, causes expansion of the fluorocarbon compound when it is used as the foaming agent. Methylene chloride has displaced most of the fluorocarbon compounds in the production of flexible foams. However, it is becoming more desirable to remove all halogen-containing compounds from the process to meet health and environmental standards. Therefore, non-halogen containing blowing agents, both in the form of liquids such as pentane and gases such as carbon dioxide may be used in accordance with the present disclosure. Fourth-generation blowing agents, typically referred to as the AFA series--which can be in both liquid and gas formulations, and include AFA molecules such as 245FA (1,1,1,3,3-pentafluoropropane, available as ENOVATE® 3000, from Honeywell International, Inc.) and 134A (1,1,1,2-tetrafluoroethane, available as FORANE® 134a, available from Arkema, Inc.) may also be optionally included in the formulations of the present disclosure, as appropriate.

A common foaming, or blowing, agent, and the preferred blowing agent for the process of the present disclosure, is water. Frequently water and an optional, auxiliary blowing agent can be used together, although this is not necessary for practicing the present invention, as water alone may be used as the blowing agent. While not intending to be limited by a particular theory, it is believed that water added to the reaction of the isocyanate and polyol reacts with the isocyanate to form an unstable carbamic acid which decomposes to the corresponding amine and carbon dioxide. The amine then reacts with another isocyanate group to form a symmetrical disubstituted urea. Either hydrogen of the disubstituted urea may react further with another isocyanate to form a biuret which provides additional polymer branching or crosslinking. The reactions of the isocyanate with water and polyol are exothermic.

As set forth above, water is preferably the sole blowing agent used in accordance with the present disclosure, to produce carbon dioxide by reaction with isocyanate. Water should be used in an amount ranging from about 0.1 to about 60 parts per hundred parts (pphp) of natural polyol, by weight (pphp), preferably between about 2 and about 50 pphp, more preferably between about 3 and about 30 pphp, as well as in amounts between these ranges, such as between about 3.5 pphp and about 6 pphp, e.g., about 4.5 pphp. At foam indexes below 100, the stoichiometric excess of water blows via vaporization and cools the foam, and does not take part of the reaction to produce carbon dioxide.

Other blowing agents that are conventionally used in the art may be used herein, in combination with the water blowing agent, but because of the utility of the current formulation, large amounts of such agents are no longer needed and in many cases none are needed at all. Fluorocarbon compounds, such as trichlorofluoromethane, have been used because they expand easily when heated and they do not react with the polyol and isocyanate. Fluorocarbon compounds continue to be used in the production of some rigid foams; however, methylene chloride has displaced most of the fluorocarbon compounds in the production of flexible foams. While a goal of the present invention is to produce soft PU foams using water as the primary blowing agent, inert physical blowing agents such as trichlorofluoromethane, or acetone nevertheless can be included. While the amount of inert blowing material may range from about 0 to about 30 pphp, commercially acceptable foams can generally be made using between about 0 and about 8 pphp, typically between about 0 and about 5 pphp, more typically between about 1 and about 3 pphp.

It is desired to replace as much as possible of the halogen containing foaming agent with a non-halogen foaming agent, e.g. water, carbon dioxide, formic acid, bicarbonates, and the like, and it is preferred in accordance with the present disclosure to only use a non-halogen foaming agent.

When, as preferred in this invention, water is provided as the foaming agent, the water/isocyanate reaction generates carbon dioxide which expands to provide the expansion or foaming of the polyurethane being produced. One of the main problems involved in replacing the ozone-depleting fluorocarbon compound as blowing agent in flexible polyurethane foams with water is the increased firmness of the resulting foams. This is likely due to the bidentate urea groups introduced as a result of the water-isocyanate reaction. With MDI- or TDI-based flexible foams, this problem can be compounded because they are selected for their softness and flexibility and the increased stiffness makes the foams less desirable. One method, as found in this invention, to obtain softer water-blown foams is to use plasticizers, some of which double as flame retardants.

### Plasticizers

The use of water as the foaming (or blowing) agent in flexible polyurethane foams increases the firmness of the resulting foams. A soft, flexible, plasticized water-blown polyurethane foam composition can be produced from the reaction of a polyol and MDI or an equivalent isocyanate by adding a plasticizer selected from the group consisting of benzoates, phenols, phthalates, phosphates or phosphorus-containing or classified as flame retardants, as well as mixtures or combinations thereof, to the reaction mixture. Exemplary types of plasticizers used in this invention are described in U.S. Pat. No. 5,624,968, the relevant disclosure of which is incorporated by reference herein.

The polyurethane foam compositions of the present disclosure can include one or more plasticizers selected from the group of phthalate plasticizers, phosphate or phosphorus-containing plasticizers and benzoate plasticizers to the reaction compounds. These plasticizers may be added to produce a softer, more flexible polyurethane foam which, more importantly, displays good load bearing properties without significant loss of the other required strength properties.

The effective level of plasticizers is very broad. Typically, acceptable polyurethane foams prepared in accordance with the methods of the present disclosure will incorporate plasticizer and/or flame retardant compounds in an amount ranging from about 0.1 to about 40 pphp, inclusive. While this range is preferred, it is recognized that less plasticizer and/or flame retardant may be added and that this reduced amount of plasticizer will provide some softening effect upon the composition, and greater amounts of plasticizer may be desired in some compositions. Typically the amount is between about 0.5 pphp and about 35 pphp, preferably between about 1 pphp and about 30 pphp, more preferably between about 1.5 pphp and about 25 pphp, inclusive, as well as amounts or ranges within these ranges, e.g., about 24 pphp, or from about 6 pphp to about 12 pphp. Such amounts may be as pure solid or liquid compounds, or the plasticizer may be dissolved in an appropriate solution or liquid, in concentrations ranging from about 2 molar to about 40 molar, more preferably from about 5 molar to about 15 molar, inclusive, as well as concentrations within these ranges, such as about 7 molar, or about 12 molar.

Plasticizers useful in this invention include phthalate plasticizers such as, for example, alkyl aryl phthalates, or alkyl benzyl phthalates, including butyl benzyl phthalate, alkyl benzyl phthalate, preferably wherein the alkyl group has a carbon chain of from seven to nine carbon atoms, Texanol™ benzyl phthalate, (which is 2,2,4-trimethyl-1,3-pentanediol-monobutyrate benzyl phthalate), alkyl phenyl phthalate, symmetrical and unsymmetrical dialkyl phthalates including diisononyl phihalate, diisodecyl phthalate, dioctyl phthalate, Di-n-butyl phthalate, Dioctyl phthalate, dihexyl phthalate, diheptyl phthalate, butyloctyl phthalate, linear dialkyl phthalate wherein the alkyl groups are independently carbon chains having from seven to eleven carbon atoms, and butyl cyclohexyl phthalate; phosphate plasticizers such as tris-(2-chloro-1-methylethyl)phosphate, tris-(alpha-chloroethyl)phosphate (TCEP), tris-(2,3-dichloro-1-propyl) phosphate, YOKE-V6 (tetrakis-(2-chloroethyl)dichloroisopentyldiphosphate), and the like; phosphate ester plasticizers such as, for example, 2-ethylhexyl diphenyl phosphate, isodecyl diphenyl phosphate, mixed dodecyl and tetradecyl diphenyl phosphate, trioctyl phosphate, tributyl phosphate, butylphenyl diphenyl phosphate and isopropylated triphenyl phosphate; and benzoate plasticizers such as, for example, Texanol™ benzoate (which is 2,2,4-trimethyl-1,3-pentanediol-monobutyrate benzoate), glycol benzoate, propylene glycol dibenzoate, dipropylene glycol dibenzoate, and tripropylene glycol dibenzoates.

Preferred plasticizers in accordance with selected embodiments are the phthalate and the phosphate or phosphorus-containing plasticizers, such as alkyly, aryl, or alkyl substituted aryl phosphates. More preferably, the plasticizers are phosphorus containing plasticizers, such as TCPP (tris(chloroisopropyl)phosphate, TCPP-LO, TCEP (tris(chloroethyl)phosphate, tris (chloropropyl)phosphate, tri-cresyl phosphate, TDCP and TDCP-LV, with the most preferable plasticizer being TMCP, tris-(2-chloro-1-methylethyl)phosphate, which is also a fire retardant. Other phosphates or phosphonates may also be used as flame retardant additives in accordance with the present disclosure, in an effective amount.

By an effective amount of the flame retardant additive, it is meant that amount sufficient to meet or exceed the test standards set forth in DIN 4102 B2 flammability test, or the ASTM E-84 flame and smoke tests. Generally, this can be in the range of from about 1 phr (parts per hundred) to about 150 phr of the flame retardant additive, based on the total weight of the flame retarded polyurethane foam or flame retarded polyurethane foam formulation. In some embodiments, an effective amount is to be considered in the range of from about 2 phr to about 100 phr more preferably in the range of from about 3 to about 60 phr, both on the same basis.

The flame retardant additive of the present invention also provides for polyurethane or polyisocyanurate foams having low smoke emissions and/or low surface flame spread. By low smoke emissions, it is meant that the polyurethane foam containing an effective amount of a flame retardant additive as described herein has a corrected smoke density, as determined by ASTM E-84 in non-flaming mode, in an amount less than about 450. By low surface flame spread, it is meant that the polyurethane foam product has a corrected flame spread, as determined by ASTM E-84, of about 5 or less, especially for foams with a density from about 0.5 lb/ft³ to about is 5 lb/ft³.

Other plasiticizers that may be used in accordance with the present disclosure include ethoxylated aliphatic monohydric or polyhydric alcohols, alkyl or alkylphenol oxylalkylates, and alkyl phenols. The water-soluble esters of the ethoxylated C₈-C₃₆ aliphatic monohydric or polyhydric alcohols with aliphatic acids, and aliphatic dimer acids may be utilized in accordance with this invention. Such ethoxylated esters have a hydrophilic-lipophilic balance (HLB) in the range of 10 to 20.

Useful ethoxylated aliphatic acids have about 5 to about 20 moles of ethylene oxide added per mole of acid. Examples include ethoxylated oleic acids, ethoxylated stearic acid and ethoxylated palmitic acid. Useful ethoxylated dimer acids are oleic dimer acid and stearic dimer acid. Aliphatic acids can be either branched or straight-chain and can contain from about 8 to about 36 carbon atoms. Useful aliphatic acids include azelaic acid, sebacic acid, dodecanedioic acid, caprylic acid, capric acid, lauric acid, oleic acid, stearic acid, palmitic acid and the like. Especially useful for the purpose of obtaining the water-soluble esters of this invention are aliphatic, preferably the saturated and straight-chain mono- and dicarboxylic acids containing from about 8 to 18 carbon atoms.

In accordance with other aspects of the present disclosure, the plasticizer can be an alkyl or alkyl phenol oxylalkylate, or similar compound which may also be classified as a nonionic surfactant. Such preferred plasticizers include, but are not limited to, alcohol oxylalkylates, alkyl phenol oxylalkylates, nonionic esters such as sorbitan esters and alkoxylates of sorbitan esters. Examples of suitable compounds include but are not limited to, castor oil alkoxylates, fatty acid alkoxylates, lauryl alcohol alkoxylates, nonylphenol alkoxylates, octylphenol alkoxylates, tridecyl alcohol alkoxylates, such as POE-10 nonylphenol ethoxylate, POE-100 nonylphenol ethoxylate, POE-12 nonylphenol ethoxylate, POE-12 octylphenol ethoxylate, POE-12 tridecyl alcohol ethoxylate, POE-14 nonylphenol ethoxylate, POE-15 nonylphenol ethoxylate, POE-18 tridecyl alcohol ethoxylate, POE-20 nonylphenol ethoxylate, POE-20 oleyl alcohol ethoxylate, POE-20 stearic acid ethoxylate, POE-3 tridecyl alcohol ethoxylate, POE-30 nonylphenol ethoxylate, POE-30 octylphenol ethoxylate, POE-34 nonylphenol ethoxylate, POE-4 nonylphenol ethoxylate, POE-40 castor oil ethoxylate, POE-40 nonylphenol ethoxylate, POE-40 octylphenol ethoxylate, POE-50 nonylphenol ethoxylate, POE-50 tridecyl alcohol ethoxylate, POE-6 nonylphenol ethoxylate, POE-6 tridecyl alcohol ethoxylate, POE-8 nonylphenol ethoxylate, POE-9 octylphenol ethoxylate, mannide monooleate, sorbitan isostearate, sorbitan laurate, sorbitan monoisostearate, sorbitan monolaurate, sorbitan monooleate, sorbitan monopalmitate, sorbitan monostearate, sorbitan oleate, sorbitan palmitate, sorbitan sesquioleate, sorbitan stearate, sorbitan trioleate, sorbitan tristearate, POE-20 sorbitan monoisostearate ethoxylate, POE-20 sorbitan monolaurate ethoxylate, POE-20 sorbitan monooleate ethoxylate, POE-20 sorbitan monopalmitate ethoxylate, POE-20 sorbitan monostearate ethoxylate, POE-20 sorbitan trioleate ethoxylate, POE-20 sorbitan tristearate ethoxylate, POE-30 sorbitan tetraoleate ethoxylate, POE-40 sorbitan tetraoleate ethoxylate, POE-6 sorbitan hexastearate ethoxylate, POE-6 sorbitan monstearate ethoxylate, POE-6 sorbitan tetraoleate ethoxylate, and/or POE-60 sorbitan tetrastearate ethoxylate. Preferred plasticizers of this class include alcohol oxyalkyalates such as POE-23 lauryl alcohol and alkyl phenol ethoxylates such as POE (20) nonyl phenyl ether. Other applicable plasticizers are esters such as sorbitan monooleate.

A further type of plasticizer which may be used in the formulations of the present disclosure include alkyl phenols, preferably non-toxic alkyl phenols, including but not limited to nonyl phenol, dodecyl phenol, di-sec amyl phenol, and the like, as well as combinations thereof.

### Crosslinker/Extender

Prior art reports that, depending upon the formulation of the natural polyol-based foam, it is possible to overcome physical property deficiencies of water-blown PU foams that contain plasticizers such as phthalates, benzoates and phosphate esters, and at the same time help avoid dangerously high exotherms, by incorporating an optional chain extender/crosslinker into the foam formulation at low indices.

One or more specific crosslinker/chain extenders may be incorporated into the foam formulation. As used herein, the term “crosslinker” is meant to include both compounds generally known as crosslinkers and compounds generally known as chain extenders or simply extenders. Crosslinkers are compounds that contain two or more isocyanate-reactive groups, such as hydroxyl groups, primary amines, and secondary amines.

Prior art reports that the crosslinking/extending agent should be present between about 0.1 and about 10 pphp and preferably, between about 0.2 and about 5 pphp. It is recognized that smaller quantities of crosslinker/extender compounds will provide some benefit, and that larger quantities are also generally effective. The specified ranges were preferred for economic as well as foam property concerns.

### Additives

In addition to the polyol, water, isocyanate, plasticizer, and crosslinker, a variety of additional additives may be included in the A-side or B-side, preferably the B-side, of the composition. These additives include catalysts, cell openers, chain extenders, fillers, and the like.

Other materials can optionally be added to the polyurethane during production to reduce problems during production or to provide desired properties in the polyurethane product. Among the additives are catalysts such as amines and metal salts; cell regulators or surfactants such as silicones (e.g., SILSTAB 2760 or Dabco® DC5604 (a silicone glycol copolymer available from Air Products and Chemicals, Inc., Allentown, Pa.)) to aid thorough mixing of the ingredients and to regulate cell growth and cell formation in the foam, including silicon dioxide, particularly in amounts ranging from about 1 part per 100 parts to about 10 parts per 100 parts, particularly from about 1.5 parts per 100 parts to about 5 parts per 100 parts, inclusive; fillers including reground PU, calcium carbonate, barium sulfate, and the like; colorants; UV stabilizers; fire retardants; bacteriostats; cell openers; and antistatic agents. It is also desirable to include stabilizers and antioxidants such as hindered amine light stabilizers and benzotriazoles.

### Surfactant/Cell Openers

A surfactant, usually a polyether-polysiloxane copolymer, can optionally be included and functions as an emulsifier, nucleating agent, and foam stabilizer.

Suitable surface active agents (also known as surfactants) for slabstock applications include “hydrolysable” polysiloxane-polyoxyalkylene block copolymers. Another useful class of foam surface active agents are the “non-hydrolyzable” polysiloxane-polyoxyalkylene block copolymers.

### Catalysts

The catalysts which may be used in the preparation of the natural polyol-based polyurethane foams of the present disclosure can be any suitable catalyst known to the art and suitable for use in the manufacture of polyurethane foams, for example organometallic polyurethane catalysts, used to promote the reaction of the isocyanate source with the polyol. The catalyst can be an amine, organometallic compound, an organic acid salt of a metal, a tertiary phosphine, an alkali metal compound, radical forming agents, and like catalyst used in forming polyurethanes.

Amines which may be used as the catalyst in the present invention include, for example, and without limitation, trialkylamines, such as triethylene amine; N,N,N′,N′-tetramethyl-1,3-butanediamine; amino alcohols such as dimethyl ethanolamine; ester amines such as ethoxylamine, ethoxyldiamine, bis-(diethylethanolamine)adipate, 1,3,5-tris-(3-dimethylaminopropyl)-1,3,5-triazine, bis-(3-dimethylaminopropyl)methyl-amine, and bis(2-dimethylamino ethyl)ether; triethylenediamine; cyclohexylamine derivatives such as N,N-dimethylcyclohexylamine; morpholine derivative such as N-methylmorpholine; piparazine derivatives such as N,N′-diethyl-2-methylpiparazine, N,N′-bis-(2-hydroxypropyl)-2-methylpiparazine, bis(2,2′-dimethylaminoethyl)ether; amidines such as 1,8-diazabicycloundec-7-ene (DBU), and combinations thereof.

The catalysts suitable for use in accordance with the processes and compositions of the present disclosure can also be alkali metal and alkali metal salt compounds, including potassium acetate, potassium octoate, and similar alkali metal or alkali metal salt compounds. Similarly, alkali metal salts of organic carboxylic acids (alkali metal carboxylates), metal alcoholoates, metal phenolates, metal hydroxides, and or quaternary ammonium salts may be used in accordance with the teachings herein.

Metals of organometallic compounds include, for example, tin, lead, bismuth, cadmium, cobalt, aluminum, potassium, chromium and zinc, may also be used as catalysts in some aspects of the disclosure. Among them, typical embodiments of organotin compounds are dibutyltin dilaurate and dibutyltin bis(2-ethylhexanoate) and the like. As for the various organic acid salts of metals, there are, for example, organic acid salts of oleic acid, naphthoic acid, caproic acid, caprylic acid, and most other organic acids with tin, lead, bismuth, cadmium, cobalt, aluminum, potassium, chromium and zinc.

Examples of organic acid salts of tin suitable for use herein are stannous oleate, tin 2-ethylcaproate, tin naphthoate, tin octylate and the like. Examples of tertiary phosphines suitable for use as catalysts in accordance with the present disclosure include trialkyl phosphine, dialkylbenzyl phosphine and the like, without limitation. Examples of alkali metal compounds include alkali metal hydroxides or fatty acid salts.

As an exemplary radical-forming agent, there are, for example, benzoyl peroxide, lauroyl peroxide, azobisisobutyronitrile and the like which are suitable for use herein.

These catalysts may be used singly or in combination with each other, as appropriate. For example, in accordance with select aspects of the present disclosure, it may be more effective to use an amine together with an organometallic compound or an organic acid salt of a metal.

Suitable catalysts include, but are not limited to, dialkyltin salts of carboxylic acid, tin salts of organic acids, triethylene diamine, bis(2,2′-dimethylaminoethyl)ether, bis(2-dimethylaminoethyl) ether, and similar compounds that are well known to the art. An exemplary suitable blowing agent catalyst suitable for use herein is Dabco® BL-19 catalyst (bis(2-dimethylaminoethyl) ether, or Polycat® 31, a non-emissive amine catalyst, both available from Air Products and Chemicals, Inc., Allentown, Pa.).

Prior art reports that catalysts should be present in an amount ranging from about 0.0001 to about 5 weight percent (wt. %), inclusive, of the reaction mixture, total, as appropriate, and depending upon the final density of the foam product produced from the reaction process. Exemplary amounts of blowing catalyst were from about 1 wt. % to about 4.5 wt. %, and from about 2 wt.

% to about 4 wt. %, inclusive.

### Emulsifiers

Emulsifiers may be importantly added to the natural polyol containing polyurethanes in accordance with the present disclosure, such as TERGITOL™ NP-9 and BM-400 emulsifier (BASF, Wyandotte, Mich.), and the like, as well as emulsifiers such as lecithin, including soy lecithin, in a variety of concentrations ranging from about 0.5% (v/v) to about 10% (v/v), for the purpose of preventing any of the natural polyol from coming out of solution prematurely. Other compositions which may be included so as to prevent natural polyols, such as sucrose, from crystallizing out of solution prematurely include invert (e.g., a 6-10% invert solution), water-soluble proteins, such as albumin; and natural sugar esters, such as sorbitan monooleate, and sorbitan monolaurate.

### Fillers/Modifiers

In some embodiments, a char-promotion agent also servers as a filler. In other examples, both a char-promotion agent, and a flame retardant agent serve as fillers.

Solid stabilizing polymers and other additives, including flame retardants, colorants, dyes and anti-static agents, which are conventionally known in the art may be used with various polyurethane foam formulations.

Other optional fillers and additives such as esters of aliphatic polyhydroxy compounds and unsaturated carboxylic acids may also be used, as appropriate or desired. Non-limiting examples include acrylates, such as ethylene glycol diacrylate; triethylene glycol diacrylate; tetramethylene glycol diacrylate; trimethylolpropane triacrylate; trimethylolethane triacrylate; pentaerythritol diacrylate; pentaerythritol triacrylate; pentaerythritol tetraacrylate; dipentaerythritol tetraacrylate;dipentaerythritol pentaacrylate; dipentaerythritol hexaacrylate; tripentaerythritol octaacrylate; glycerol diacrylate; methacrylates, such as triethylene glycol dimethacrylate; tetramethylene glycol dimethacrylate; trimethylolpropane trimethacrylate; trimethylolethane trimethacrylate; pentaerythritol dimethacrylate; pentaerythritol trimethacrylate; pentaerythritol tetramethacrylate; dipentaerythritol dimethacrylate; dipentaerythritol trimethacrylate; dipentaerythritol tetramethacrylate; tripentaerythritol octamethacrylate; ethylene glycol dimethacrylate; 1,4-butanediol dimethacrylate; sorbitol tetramethacrylate and the like; itaconates, such as ethylene glycol diitaconate; propylene glycol diitaconate; 1,2-butanediol diitaconate; tetramethylene glycol diitaconate; pentaerythritol triitaconate and the like; crotonates such as ethylene glycol dicrotonate; diethylene glycol dicrotonate; pentaerythritol tetracrotonate and the like; and maleates, such as ethylene glycol dimaleate; triethylene glycol dimaleate; pentaerythritol dimaleate and the like.

In accordance with selected embodiments of the present disclosure, it may be particularly advantageous to add an optional anti-oxidant, such as a hindered phenolic, i.e., IRGANOX™ 1010 (Ciba-Geigy), an organic phosphite, or both, to the polyurethane foam composition. Such antioxidants can act to retard any discoloration associated with high temperatures in the manufacture of the foam products. Stabilizers, such as tetrabutylhexamethylenediamine, may also be optionally and beneficially added.

Additional additives that may be optionally included in the formulations of the presentinvention, particularly as a B-side component, include glycerine, or glycerine-derivatives and analogs, and glycine or glycine derivatives such as ethoxylated and propoxylated glycine, alone or in combination with one or more high (greater than 1000) molecular weight polyols, such as Pluracol® 593 (BASF, Wyandotte, Mich.). Initial results have shown that the use of glycerine or similar compounds provide increased stability in the foam products. When included in the formulation, the amount of glycerine or glycerine-derivatives ranges from about 1 parts per 100 parts to about 20 parts per 100 parts, or alternatively from about 2 parts per 100 parts to about 10 parts per 100 parts, inclusive.

### Foam Properties

In various examples, polyurethane foam products contemplated herein comprise one or more polyols; one or more organic isocyanates; and one or more char-promoting agents. Optional components include one or more flame retardant agents; blowing agents; one or more plasticizer; one or more surfactants; catalysts and emulsifiers. The products may also include as other standard ingredients known to those skilled in the art, included as appropriate depending upon the end use of the polyurethane foam product.

Airflow data provides a numerical measure of the amount of air to flow through a standard size piece of foam at a standard air pressure and temperature. This gives a measure to the relative openness or closedness of a given piece of foam. Foams with higher airflows are more open and conversely those with lower airflows are considered more closed or tighter. The airflows of the presently disclosed foams are relatively high and indicate good quality open-celled foam. Preferred airflow for optimal physical property development ranges from about 2-6 scfm at 0.5 in. Hg per ASTM test 283.

The polyurethane foam compositions of the present disclosure may be prepared to have a closed cell apparent, core density ranging from about 0.3 lb/ft.sup.3 to about 5.0 lb/ft.sup.3, inclusive, including about 0.5 lb/ft.sup.3 (pounds per cubic foot, pcf), about 1 lb/ft.sup.3, about 2 lb/ft.sup. 3, about 3 lb/ft.sup.3, and about 4 lb/ft.sup.3. Typically, a low density insulation is characterized as that foam insulation exhibiting a range per AC377 from about 0.5 be to about 1.4 lb/ft.sup.3 (pcf), as determined by ASTM standard D-1622.

The polyurethane foams of the present disclosure exhibit a number of other desired attributes, including, compliant surface burning characteristics, and compliant foam industry characteristics, as well as desirable core density, tensile strength, dimensional stability, and closed cell content values.

### Testing Method

In addition to bench and cup testing methods, applicants prepared a test building that permits a more realistic full-scale tes. In these tests, a drum quantity of Part B composition was prepared. Depending upon the test compositions, the Part A composition was standard, or additives were provided. The Part A and Part B compositions were then sprayed in the test structure, which had 16 inch center 2×4 walls and ceiling.

After drying, a flame test was performed. The foam composition was observed during the flame test, and was inspected afterwards.

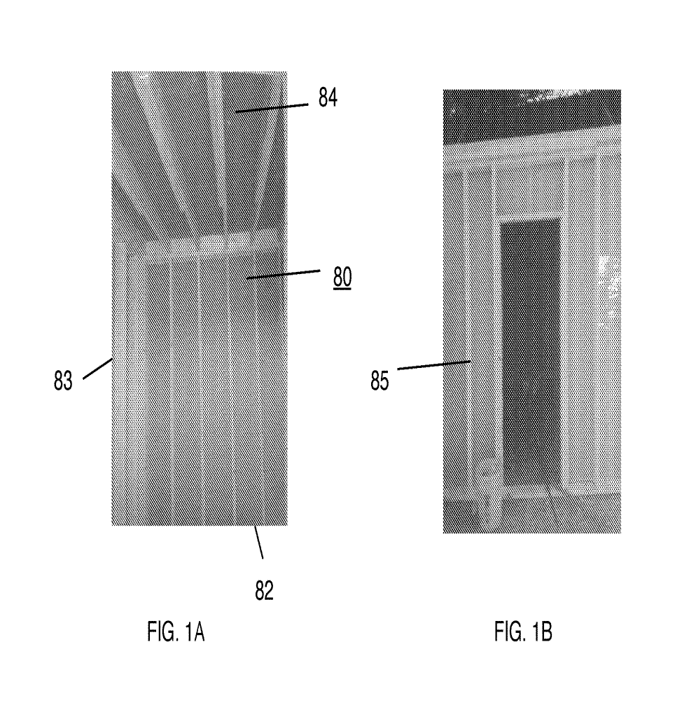

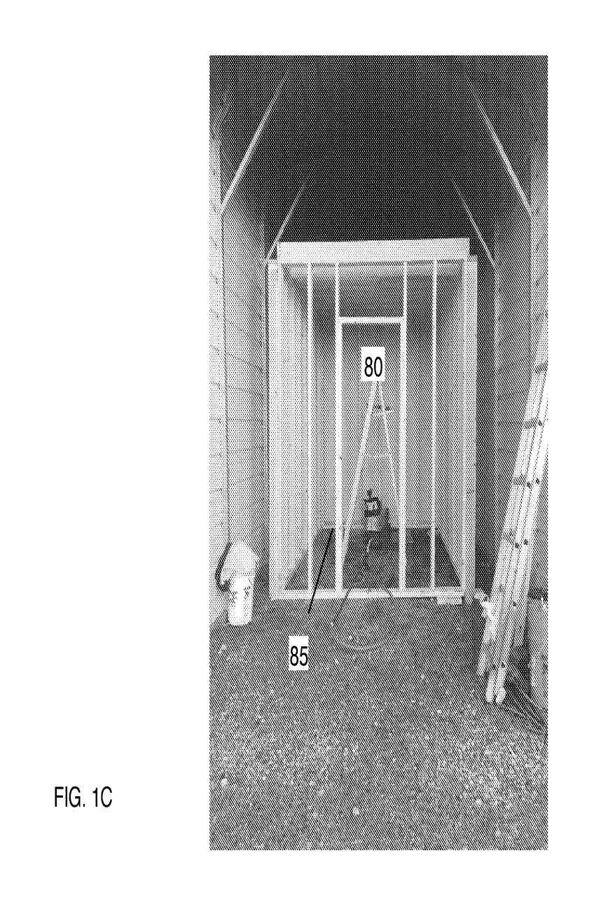

FIG. 1A is a front perspective view of a test room 80 showing the back wall 82 and left wall 83 with standard 8 foot high, 16 inch center 2×4 inch framing and sheetrock; and a ceiling 84 with 2×6 ceiling joists on 16 inch centers with sheetrock. FIG. 1B is a front view of the front wall 85 of the test room before ceiling joist installation. FIG. 1C is a front view of the test room 80 prior to sheetrock installation on the front wall 85.

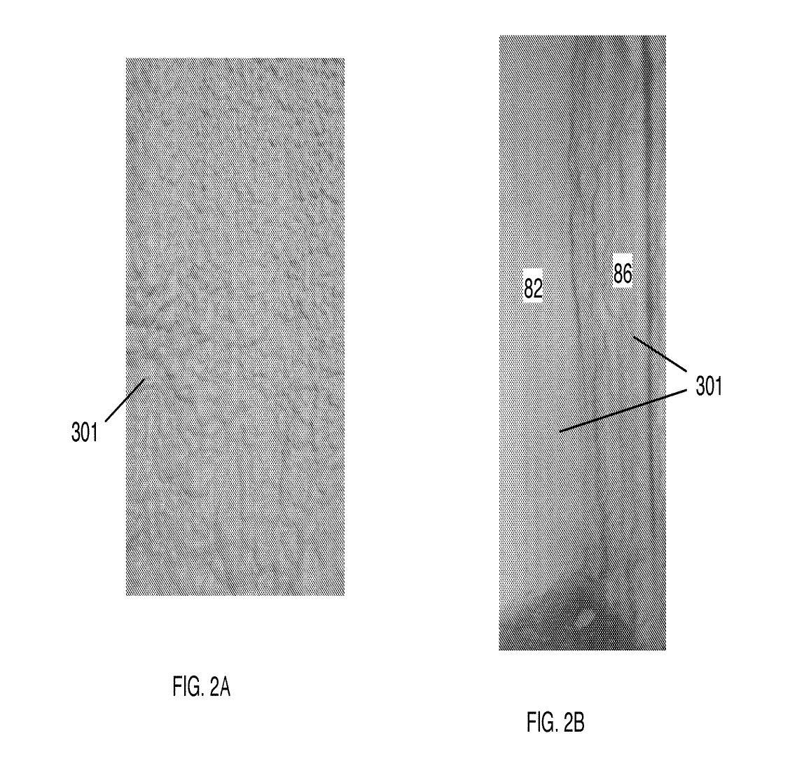

FIG. 2A is a front view of a sprayed-on polyurethane foam composition 301 with a high ground rock wool and high water composition with accelerated sunlight cure. FIG. 2B a front perspective view of the sprayed-on polyurethane foam composition 301 sprayed onto test chamber the back wall 82 and scraped even with the wall studs; and composition 301 sprayed onto the test chamber right side wall 86 before scraping.

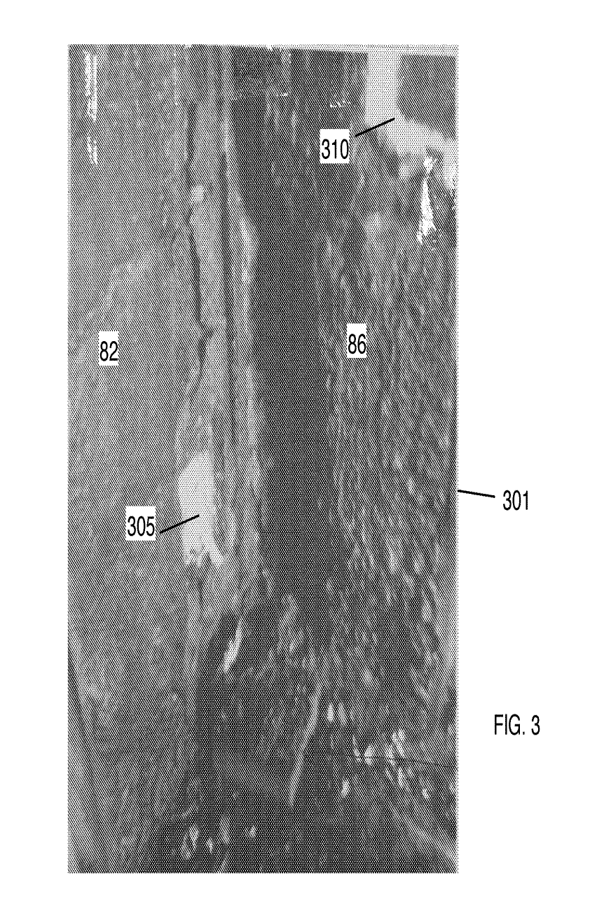

FIG. 3 is a front view of a sprayed-on polyurethane foam composition 301 after a test burn. The right wall was scared before the burn. A section 305 of the back wall foam has been removed, and a section 310 of the right side wall has been removed

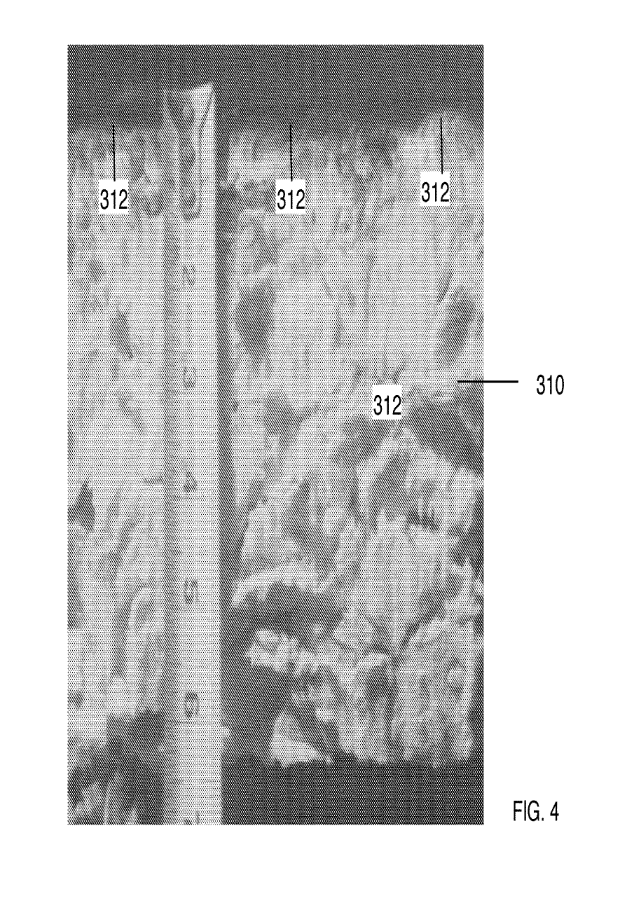

FIG. 4 is a side view of right wall section 31l after the test burn, showing a well-defined thin char layer 312.

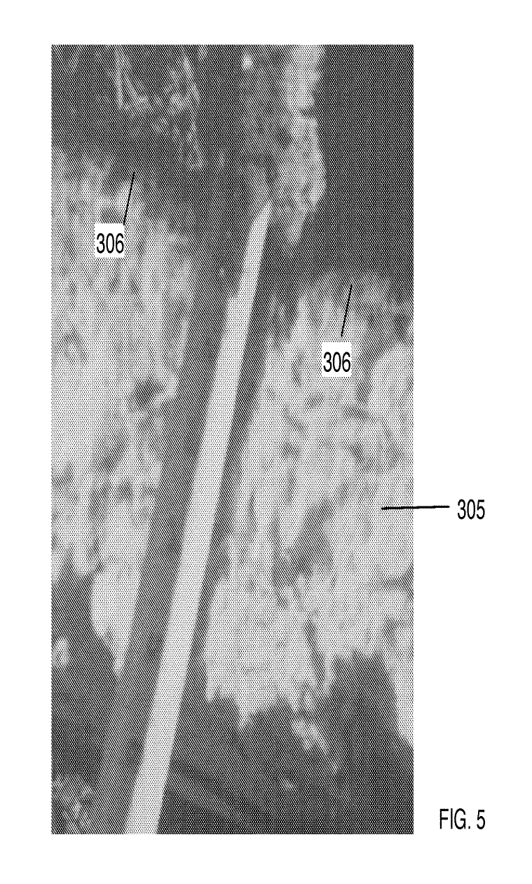

FIG. 5 is a side view of back wall section 305 after the test burn, showing a well-defined thin char layer 306.

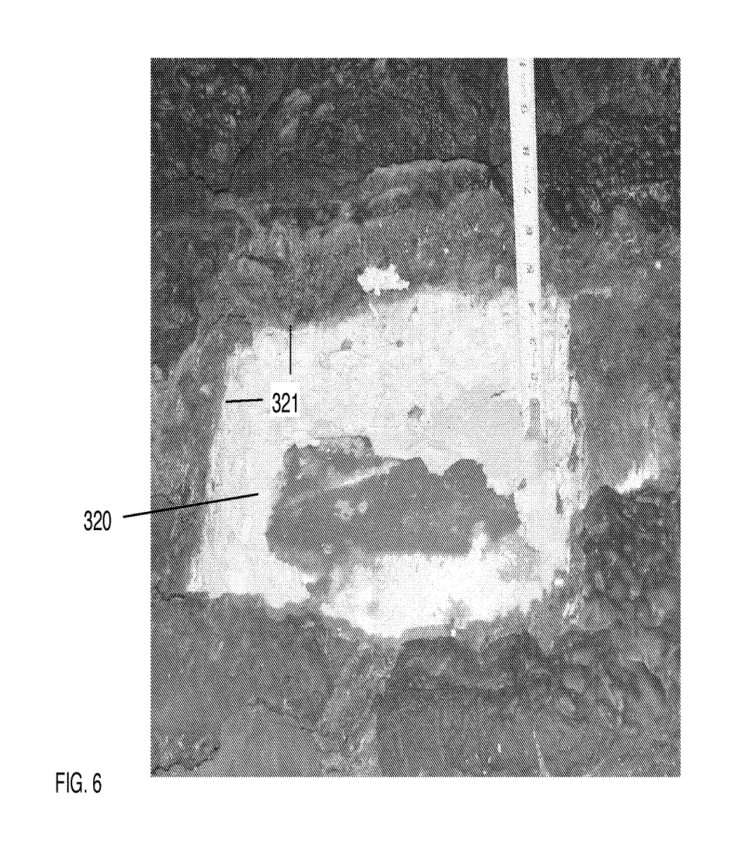

FIG. 6 is a bottom view of a ceiling wall section cutout 320 after the test burn, showing a well-defined thin char layer 321.

### Foam Products and Applications

The polyurethane foams of the present disclosure are suitable for use in a number of applications, ranging from insulation (such as spray-in-insulation) to spray foam to structural panels, spray rooming, and the like. For example, low-density polyurethane foam with a core density ranging from 1.0 pcf to 3.0 pcf may be used in coolers, structural insulated panels (SIPs), insulated panels, walk in coolers, refrigerators, refrigerated truck bodies, water heaters, SPA Foam, insulated building panels, freezers, roofing panels, replacement for polyisocyanurate board, and packaging foam. Polyurethane foam of the present disclosure with a core density ranging from 1.0 pcf to 5.0 pcf may be used in one-to-one packaging foam, sprayed in place packaging, prefabricated packaging slabs, or comfort foam. Polyurethane foam of the present disclosure with a core density ranging from 0.4 pcf to 5.0 pcf can be is used in the manufacture of mattresses, mattress covers, packaging, toys, furniture, office seats, car seats, car interior foam, carpet underlay, cut foam, display foam, prefabricated foam, pillows Low density molded foam. Polyurethane foam of the present disclosure with a core density ranging from 1.5 pcf to 3.0 pcf may be used in the manufacture of molded seating, molded furniture, faux wood, picture frames, cosmetic panels for homes, toys, toilet seats, medical devices, and the like. Structural Low Density Foam, that polyurethane foam of the present disclosure with a core density ranging from 1.5 pcf to 3.0 pcf, may be used in the manufacture of doors, garage doors, car panels, automotive sound damping, automotive headliners, block filling foam, and shoe liners cushions. The polyurethane products prepared in accordance with the present disclosure may also be used to produce things like low-density adhesives these are used in the fabricated home manufacturing industry.

The following examples are included to demonstrate embodiments of the invention. It should be appreciated by those of skill in the art that the techniques disclosed in the examples which follow represent techniques discovered by the inventors to function well in the practice of the invention, and thus can be considered to constitute modes for its practice. However, those of skill in the art should, in light of the present disclosure, appreciate that many changes can be made in the specific embodiments which are disclosed and still obtain a like or similar result without departing from the scope of the invention.

### Description of Embodiment—Polyurethane Foam Composition With Char-Promoting Agent

In this embodiment, agents are provided to

(1) Inhibit combustion at flame front through the char effect of the rock wool against the decomposition of the polyol-isocyinate based foam, thus decreasing the fuel available to promote continued ignition.
(2) Remove heat from the polyol-isocyanate based foam through the limited heat transfer properties of rock wool and the insulative properties of the charred surface being formed, and thₑ functional impact in Gas Phase and Condensed Phase by releasing non-flammable gases (H₂O, CO₂) which dilutes the fuel and cools the polymer through the use of a endothermic flame retardant additive such as a metal hydroxide. This is the same process that a dry powder fire extinguisher provides Sodium bicarbonate melts and decomposes at 270° C. on heating. The equilibrium reaction 2NaHCO₃<-->H₂O+CO₂+Na₂CO₃ is endothermic in the forward direction; ΔrH=91 kJ mol−1. Being endothermic the equilibrium constant increases with temperature. It changes from 1.8×10-5 at 25° C. to 4×108 at 427° C. Thus at the temperature of the fire heat is absorbed by the bicarbonate and carbon dioxide and water are produced. Thus sodium bicarbonate works by absorbing heat from the fire and giving off products which would help smother it.

Some metals can catalyze additional char formation, and sometimes additives which just slow down fuel pyrolysis rates through major increases in molten polymer viscosity (such as fumed silica and nanocomposites) can cause char to form. Specifically, the radicals in the condensed phase have more residence time in the condensed phase before volatilizing and therefore react with themselves rather than pyrolyzing and combusting. These polymers, by binding up polymeric fuel into highly cross-linked graphitic or glassy-carbon char, keep heat release rate low since there is very little mass being pyrolyzed for combustion

(3) Prevent the polyol-isocyinate based foam decomposition/fuel release through the noncombustible nature and charring effect of the mineral wool in Condensed Phase by preventing fuel release through limiting the convection process of the fire in which heat is transferred by the movement of matter itself, in a fire matter being in the gaseous state and providing thermal insulation for underlying polymer.

In the examples below, a ground rockwool is used as a char-promoting agent in a concentration between 10 and 45 weight percent:

### EXAMPLE 1

### Part B Formulation Example 1

| Order | MFG. | Product | Parts by Weight | Wt % |
|---|---|---|---|---|
| 1 | | Water | 40.00 | 15.22 |
| 2 | | Rockwool | 40.00 | 15.22 |
| 3 | | Mg(OH)2 | 20.00 | 7.61 |
| 4 | | TCPP | 60.00 | 22.83 |
| 5 | Huntsman | 360/355 | 19.92 | 7.58 |
| 6 | Huntsman | 5815/6015 | 29.95 | 11.40 |
| 7 | Great Lakes | pht-4-diol | 40.00 | 15.22 |
| 8 | Huntsman | N-95 | 3.80 | 1.45 |
| 9 | SILTECH | 2760 | 1.50 | 0.57 |
| 10 | Huntsman/Air Products | z-110 | 1.10 | 0.42 |
| 11 | Huntsman | ZR20 | 1.10 | 0.42 |
| 12 | Huntsman | ZR70 | 3.25 | 1.24 |
| 13 | Huntsman | Z130 | 2.20 | 0.84 |

### EXAMPLE 2

### Part B Formulation Example 2

| | | | Parts by | |
|---|---|---|---|---|
| Component | MFG. | Product | Weight | Wt % |
| 1 | | Water | 4000 | 29.52 |
| 2 | | Rockwool | 6000 | 44.28 |
| 3 | | TCPP/Chlorez 700 | 500 | 3.69 |
| 4 | SILTECH | 2760 | 600 | 4.43 |
| 5 | Huntsman/ | z-110 | 60 | 0.44 |
| | Air Products | | | |
| 6 | Dover | ParOil | 150 | 1.11 |
| 7 | | Hemp | 250 | 1.85 |
| 8 | Huntsman | ZR20 | 60 | 0.44 |
| 9 | Huntsman | ZR70 | 550 | 4.06 |
| 10 | Huntsman | N-95 | 1200 | 8.86 |
| 11 | Great Lakes | pht-4-diol | 120 | 0.89 |
| 12 | Huntsman | Z130 | 60 | 0.44 |

### EXAMPLE 2

### Part B Formulation Example 3

| Component | MFG. | Product | Parts by Weight | Wt % |
|---|---|---|---|---|
| | | ThermaSeal 500 | 100 | 71.4 |
| | | Rockwool | 15 | 10.7 |
| | SILTECH | Mg(OH)2 | 8 | 5.7 |
| | | 2760 | 4 | 2.9 |
| | | NPq | 6 | 4.3 |
| | Huntsman | ZR20 | 2 | 1.4 |
| | | Water | 5 | 3.6 |

### Description of Embodiment—Polyurethane Foam Composition with Char-Promoting Agent and Flame Retardant Agent

In other examples, a char-promoting agent, such as ground rockwool may be used in combination with endothermic decomposition agents or flame retardant agents such as magnesium hydroxide or potassium bicarbonate, Huntite Hydromagnesite, Zirconium Silicate, Calcium chloride, or Zirconium Oxide.

It is to be understood that the specific embodiments and examples described above are by way of illustration, and not limitation. Various modifications may be made by one of ordinary skill, and the scope of the invention is as defined in the appended claims.

What is claimed is:

1. An additive composition for improving flame or fire retardant properties of polyurethane foam, the additive composition comprising
a char-promoting component comprising
a first ceramic, glass, mineral, or slag material having a particle size in the range of 1 to 6730 microns.

2. The additive composition of claim 1 wherein the char-promoting component comprises
a first ceramic, glass, mineral, or slag material having a particle size in the range of 1 to 1680 microns.

3. The additive composition of claim 1 wherein the char-promoting component comprises
a first ceramic, glass, mineral, or slag material having a particle size in the range of 1 to 595 microns.

4. The additive composition of claim 1 wherein the char-promoting component comprises
a ground mineral wool having a particle size in the range of 1 to 595 microns.

5. The additive composition of claim 4 wherein
the char-promoting component is a ground rockwool.

6. The additive composition of claim 1 further comprising
a flame retardant component in the range of 2 to 45 percent by weight; and

7. The additive composition of claim 6 wherein
the flame retardant agent is an endothermic decomposition agent.The additive composition of claim 10 wherein

8. The additive composition of claim 7 wherein
the flame retardant agent is magnesium hydroxide.

9. An open cell polyurethane spray foam insulation composition comprising a
Part A, isocyanate, foam insulation composition;
a Part B, polyol, foam insulation
composition; and
ground mineral wool.

10. The open cell polyurethane spray foam insulation composition of claim 9 further comprising
a flame retardant agent in the range of 2 to 45 weight percent.

11. The open cell polyurethane spray foam insulation composition of claim 9 further comprising
a ground mineral wool is provided in the Part A, polyol, foam insulation composition in the range of 2 to 45 weight percent.

12. The open cell polyurethane spray foam insulation composition of claim 9 further comprising
a Part A, isocyanate, foam insulation composition comprising
a Part B, polyol, foam insulation composition comprising
ground mineral wool in the range of 10 to 45 weight percent, and water in the range of 2 to 35 weight percent.

13. The open cell polyurethane spray foam insulation composition of claim 9 further comprising
a flame retardant agent.

14. The open cell polyurethane spray foam insulation composition of claim 13 wherein the flame retardant agent is an endothermic decomposition agent.

15. The open cell polyurethane spray foam insulation composition of claim 14 wherein the flame retardant agent is magnesium hydroxide.

16. The open cell polyurethane spray foam insulation composition of claim 15 wherein
the flame retardant agent is magnesium hydroxide in the range of 2 to 40 weight percent.

17. The open cell polyurethane spray foam insulation composition of claim 12 wherein
the mineral wool char-promotion agent is a ground rock wool having a particle size of 1 to 595 microns.

18. A method of using a ground mineral wool material to improve char-creation properties of a flammable material, the method comprising
producing a powder by grinding a ceramic, glass, mineral, or slag mineral wool to a particle size of 1 to 595 microns;
adding the powder to Part A or Part B of a isocyanate/polyol foam composition in a concentration range of 2 to 40 weight percent.

19. The method of claim 6 further comprising
creating a polyurethane foam from the Part A or Part B of a polyol/isocyanate foam composition.
